(19) United States
(12) Patent Application Publication
(10) Pub. No.: US 2014/0076101 A1
(43) Pub. Date: Mar. 20, 2014

(54) Bicycle Shoe and Methods of Manufacture

(71) Applicant: Stephen C. McNeil, Canton, MA (US)

(72) Inventor: Stephen C. McNeil, Canton, MA (US)

(21) Appl. No.: 13/623,729

(22) Filed: Sep. 20, 2012

(51) Int. Cl. A43B 5/14; B62M 3/08; B29D 35/14

(52) U.S. Cl. CPC A43B 5/14; B29D 35/14; B62M 3/086
USPC 74/594.6; 264/223; 36/131

(57) ABSTRACT

A novel bike shoe (and related methods of use and fabrication) and bike shoe/pedal system that allows the rider to either slide their foot in and out of the shoe while it remains attached to the pedal or mount/dismount from the pedal while wearing the shoe.

This application claims priority under 35 U.S.C. §119(e) to co-pending U.S. Provisional Application Ser. No. 61/537,834 filed on Sep. 22, 2011, herein incorporated by reference in its entirety.

### FIELD OF THE INVENTION

The present invention generally relates to a novel bike shoe (and related methods of use and fabrication) and bike shoe/pedal system that allows the rider to either slide their foot in and out of the shoe while it remains attached to the pedal or mount/dismount from the pedal while wearing the shoe.

### BACKGROUND

There are several bike shoes on the market that are called “custom” made products. However, companies on the market, such as the Australian company Bont Cycling, base their custom design on a flat, plantar surface mold, and not on a complete total foot mold.

What is needed is a reproducible, durable, custom mold that a bicycle shoe can be manufactured from that offers several unique features that are currently not present in other bicycle shoes.

### SUMMARY OF THE INVENTION

The present invention generally relates to a novel bike shoe (and related methods of use and fabrication) that allows the rider to either slide their foot in/out of the shoe while it remains attached to the pedal or mount/dismount from the pedal while wearing the shoe, thereby providing an alternative bike shoe unique to the industry. In one embodiment, the biker will have the option to slide his foot out of the shoe and slide back in (i.e. in the case where the shoe remains attached to the bike), or dismount off the bike pedal and clip back in (i.e. in which case the shoe is detached and re-attached to the bike). In a preferred embodiment, the shoe is more durable, lighter, and more aerodynamically sound than the competitive bike shoes on the market.

In a preferred embodiment, the bike shoe is custom-made for the individual biker as a one piece, light-weight bike shoe. This bike shoe is appealing to triathletes where efficient transitioning between zones {swimming to biking, biking to running} is important. This shoe will give a competitive advantage to the triathlete because the transition time will be decreased. This shoe will be appealing to both the triathlete and serious biker because they should be able to go faster for two major reasons. 1: This shoe is much lighter and more aerodynamically sound than the existing bike shoes on the market. For example, for a size nine shoe, the shoe of the present invention has an average weight of 145 g, whereas the next lightest shoe in the market (Bont) for the same size is 185 g. 2: The durable, stiffness of the materials will allow the biker to generate a more powerful pedal stroke. Recreational bikers will also recognize that this shoe is more comfortable than currently available cages and easier to use (e.g. mount/dismount) than traditional clips because of the slide in/slide out feature.

This shoe may also be appealing to mountain bikers for 3 reasons. 1: Safety. The ability to slide the feet out during an impending fall may help prevent serious injury. 2: Durability. This shoe should last longer for the mountain biker than the current shoes on the market. 3: The ability to have the bike shoe molded for the Vibrams 5 fingers which will allow the mountain biker an alternative shoe wear to be used immediately after getting off the bike for walking or running.

The incorporation of a bike shoe/clip design (e.g. cleat on the undersurface) was found to provide excellent durability and support while still allowing rotation either internally or externally between the cleat and shoe, which can be either dialed in or eliminated, based on the individual bikers needs. The custom design further allows input from the bike fitter to maximize pedal stroke performance—for example, 1) the position of the cleat on the shoe can be adjusted to specific conditions, 2) the sole of the shoe can be built up to accommodate leg length discrepancies and 3) inserts may be incorporated within the shoe for individual alignment issues.

In one embodiment, the present invention contemplates a method of making a bicycle shoe, comprising: a) providing a hardenable, shell-forming material (e.g. fabric) and an activating solution; b) dipping (or otherwise exposing) said material (e.g. fabric) in said activating solution; c) applying said material (e.g. fabric) to a foot (e.g. by stretching it over the toes and around the heel of the foot); d) allowing sufficient time for the material (e.g. fabric) to harden and form a shell (e.g. takes approximately five minutes); e) removing the hardened shell from the foot; f) filling the hardened shell with a hardenable solution, (e.g. Plaster) under conditions such that a hardened mold of the foot is created; g) covering the foot mold with spacer material (i.e. material that will ultimately provide more room for the foot by slightly increasing the size of the mold) to create an expanded foot mold; h) adding composite materials to the top and bottom of the expanded foot mold to create a precursor shoe; i) treating (e.g. laminating) said precursor shoe with a solution which penetrates and solidifies the composite materials to form a first treated (e.g. laminated) shoe; j) attaching a cleat linking element or cleat engaging device to the bottom of said first treated (e.g. laminated) shoe with precision with the use of a foot scale and proper measurements, said cleat linking element configured to engage a cleat, said cleat configured to clip into a receptacle on a bicycle pedal; k) (optionally) treating (e.g. laminating) said first treated (e.g. laminated) shoe to create a twice treated (e.g. twice laminated) bicycle shoe; and l) removing the hardened mold thereby freeing the (e.g. twice laminated) bicycle shoe from the mold. In one embodiment, after step k), the method proceeds as follows: l) securing the shoe with the use of the cleat fixation element in a computer controlled (“C&C”) machine, which has been programmed to create precise trim lines: m) removing the shoe from the machine, and then n) removing the hardened mold thereby freeing the (e.g. twice laminated) bicycle shoe from the mold.

In one embodiment of the method, said solution of step (i) is an acrylic resin. In one embodiment of the method, said compositing materials of step (h) comprise a carbon fiber or, alternatively, a composite fiber such as Synthex™ (commercially available from Fabtech, Everett, Wash., USA) instead of a carbon fiber. In one embodiment of the method, said spacer material comprises a plurality of layers of an elastic knitted fabric. In one embodiment, said hardenable solution comprises plaster. In one embodiment, the present invention contemplates the shoe produced by the above described embodiment of the method.

In one embodiment, the present invention contemplates a bicycle shoe, comprising: a) top, side, and bottom surfaces comprising composite materials laminated with a solution which has penetrated and solidified the composite materials, said surfaces collectively defining the dimensions of an open space inside the shoe; b) an opening in said top surface of sufficient size to permit a user to insert a foot into the open space inside the shoe in a manner wherein the toes of the foot are completely covered and the heel of the foot engages a side surface; and c) a cleat linking element or cleat engaging device positioned on said bottom surface, said cleat linking element configured to engage a cleat, said cleat configured to reversibly engage a receptacle on a bicycle pedal. In one embodiment, said top, side and bottom surfaces are prepared from a mold of the foot of said user. In one embodiment, said opening in said top surface is modified to create trim lines to permit easier insertion and extraction when compared to an unmodified opening. This manufacturing technique is unique and not used in the manufacturing process of other bike shoes. In one embodiment, the cleat linking element can be prepared with pre-made solid composite fiber such as Synthex™ composite fiber material the shape of a rectangle, with pre-made fixation holes the shape of a triangle, with the nuts already glued into these holes. The holes for the nuts will be drilled using the C&C machine. The cleat fixation elements (CFE) will be secured to the plantar surface of the shoe with adhesive material once the proper position has been determined with the use of a scale and proper measurements. The center point for cleat fixation has been determined to be at the midpoint of the midfoot MTP line which has been defined to be an oblique line from the 1^{st} MTP joint on the medial side of the foot, to the 5^{th} MTP joint on the lateral side of the foot. Once this point is determined, a second line is drawn from the center of the heel to the center of the forefoot. This line will intersect the center point. The proper alignment of the 3 points of the triangle in the CFE can then be determined. In one embodiment, the cleat linking element is removeably positioned, i.e. it can be adjusted to suit the user/rider.

In one embodiment, padded velcro straps or padded composite fiber such as Synthex™ material derived from the dorsal surface of the trimmed shoe with ratchet/buckle fixation are secured over the dorsum of the foot just posterior to the dorsal trim line. These devices can maximize the fit, but could be easily released to allow the foot to slide out of the shoe if that was the preference of the rider. In another embodiment, the present invention contemplates a posterior loop of fabric secured to the heel of the shoe to allow the rider/athlete to secure the shoe on the pedal in neutral position by looping an elastic band through the fabric. In still another embodiment, the present invention contemplates padded inserts in different thicknesses and configurations that can be easily attached to the inner shoe to maximize comfort and support. In still another embodiment, the inventor contemplates reflective decals glued to the heel, top (dorsum) and lateral side of shoe.

The present invention also contemplates, in one embodiment, a system comprising a bicycle pedal and bicycle shoe, comprising a receptacle on said bicycle pedal; and a cleat engaging a cleat linking element (or cleat engaging device) positioned on the bottom of said bicycle shoe, wherein said receptacle is capable of reversibly engaging said cleat on said pedal, said shoe comprising top, side, and bottom surfaces comprising composite materials laminated with a solution which has penetrated and solidified the composite materials, said surfaces collectively defining the dimensions of an open space inside the shoe; and an opening in said top surface of sufficient size to permit a user to insert a foot into the open space inside the shoe in a manner wherein the toes of the foot are completely covered and the heel of the foot engages a side surface. In one embodiment of this system, said top, side and bottom surfaces of the shoe are prepared from a complete mold of the foot of said user. In one embodiment, said opening in sad top surface is modified to create trim lines to permit easier insertion and extraction when compared to an unmodified opening.

The present invention also contemplates a bicycle riding method using the above described system wherein the rider dismounts the bicycle by sliding their foot in and out of the shoe while it remains attached to the pedal. In another embodiment, the rider mounts and/or dismounts from the pedal while wearing the shoe.

In one embodiment of the bike shoe mounted onto the pedal, there is the ability to allow for rotation internally and externally.

### DESCRIPTION OF THE INVENTION

The present invention generally relates to a novel bike shoe (and related methods of use and fabrication) that allows the rider to either slide their foot in/out of the shoe while it remains attached to the pedal or mount/dismount from the pedal while wearing the shoe, thereby providing an alternative bike shoe unique to the industry. In one embodiment, padding (e.g. rubber padding) is secured to the plantar aspect of the heel to allow the biker protection and safety if he or she elects to dismount from the pedal and thereby cause the shoe to bear the weight of the rider on the ground. In one embodiment, openings are employed (e.g. three ⅛ inch drill holes) on the plantar surface of the toe box to allow for ventilation and to prevent water damage by allowing the water to escape, and on the dorsal surface of the shoe for ventilation. The number of drill holes can be customized to the preference of the user/biker.

In one embodiment, the shoe is manufactured by creating a custom negative mold of the individual's foot. In one embodiment, the commercially available STS slipper sock is used. In a preferred embodiment, the commercially available STS ankle sock is used. Plaster is poured into the negative mold to create a positive foot mold. Materials are then placed over the foot mold to create sufficient space for the individual to slide the foot in and out of the shoe. Trial and error identified six layers of “stockinet” as providing the appropriate thickness to maximize efficiency and comfort to riders electing to wear the Vibrams 5 finger shoe, while various layers positioned on the foot are optimal for riders wearing socks or riding barefoot. Each layer provides ⅛ inch volume expansion. It was determined that five layers are optimal for the toe box, and two layers from the midfoot to the heel.

In one embodiment, plastic is then stretched over the foot mold and attached to a suction device to maintain the custom fit. In one embodiment, three layers of composite material—including two of composite fiber (such as Synthex™) and one of nylon—are placed over the foot mold and the undersurface of the metatarsal region to maximize strength for cleat fixation. The first lamination process is performed using acrylic resin, under suction, to penetrate and solidify the composite materials. In one embodiment, the CFE is secured to the plantar surface of the shoe with a bonding material. The second lamination process is performed in a similar fashion after one layer of composite fiber (such as Synthex™) and one layer of fabric, chosen by the customer, is applied over the foot mold. The shoe will then be secured to the machine of which a jig has been made to engage the CFE. One embodiment of such a jig is shown in FIG. 22. The proper shoe size determined by a scale will then be entered into the computer, which has been programmed to have the machine perform proportional trim lines based on the size of the foot. The shoe will then be removed from the machine. Finally, the plaster is extracted from the shoe, which is then cleaned. Optionally, a plastic socket edging material is then secured to the trim line around the shoe.

With regard to the positioning of the cleat linking element or cleat engaging device, the center of the mechanical axis in the foot goes through the midpoint of the maximum forefoot diameter. The center point for cleat fixation is found at the intersection of this line and the oblique MTP line. This is the standard center position of cleat fixation in the bike shoe industry. This is easily determined with the custom mold as mentioned before with the use of a scale and proper measurements. In one embodiment, the second lamination process of the bike shoe incorporates the CFE into the plantar aspect of the shoe. Most cleats allow for deviation of 1 cm medial to lateral and anterior to posterior from the center point. This can be achieved with the bike shoe, but this shoe is unique because the center point for cleat fixation can be adjusted based on the individual biker's anatomic variations. For example, if the rider has a fixed cavus deformity, the bike fitter may feel that the most optimal position for cleat fixation is more lateral and posterior to maximize power, efficiency and comfort. This could be marked on the user/rider's mold and easily customized for the individual. As noted above, in one embodiment, the cleat linking element removably positioned, i.e. it can be adjusted to suit the user/rider.

With regard to the trim line of the shoe, the present invention contemplates embodiments wherein the most optimal anterior and posterior trim lines are used to maximize the fit, but to allow the foot to easily slide in and out of the shoe. This optimal positioning was determined after trial and error. The most proximal aspect of the dorsal trim line was determined to be 1 inch proximal to the center point of cleat fixation. This trim line then tapers distally as it curves into both the medial and lateral trim lines. The most optimal posterior trim line was found to be at the Achilles tendon attachment on the posterior calcaneus. Any point proximal to this would cause the dorsal trim line to be moved more distal to allow the foot to slide in and out of the shoe. This would compromise the fit necessary to maximize power in the pedal stroke. The lateral trim line is ½ inch inferior to the posterior trim line. The highest point of the medial trim line is even with the posterior trim line. The extra height of the medial trim line is necessary to maintain proper arch support which is important for comfort and efficiency.

This shoe represents an improvement over “custom” made products currently on the market. For example, bike shoes provided by Bont or D2 base their custom design on a flat, plantar surface mold rather than a complete total foot mold. In addition, this bike shoe can be manufactured to weigh considerably less than any other shoe on the market. The fabric design is also unique to the industry since the acrylic resin solidifies the fabric over the custom mold into a hard, durable, comfortable, lightweight one-piece shoe. This one piece, properly fitted shoe (with reproducible volume expansion and proportional trim lines) is different from the other shoe manufactured from a total foot mold (Simmons Cycling shoes). The Simmons shoe is not a slide in/slide out shoe.

With the customized process described herein, the individual will be able to decide what he or she wants on their feet for the custom bike shoe (e.g. stockings or light weight protective shoes such as the Vibram's five fingers, or minimalistic sneakers or nothing, i.e. barefoot).

In one embodiment, the present invention contemplates utilizing automated Cad/Cam and C&C (computer control) technology in the process of making the shoe. In one embodiment, the present invention contemplates utilizing computer software systems available that can make precise trim lines which is critical to both the proper fit and efficiency of the shoe.

### BRIEF DESCRIPTION OF THE FIGURES

FIGS. 1A and 1B show a first prototype in which an orthotist made a partial plaster mold of the front part of a human subject's foot while wearing Vibram's running shoes.

FIGS. 2A and 2B show a second prototype of a bike shoe using a full foot mold to provide additional support.

FIG. 3 depicts a prototype of a full foot bike shoe with a cleat incorporated into the undersurface.

FIG. 4A depicts a negative mold of a subject's foot made using the STS slipper sock. FIG. 4B depicts a negative mold of a subject's foot made using the STS ankle sock, which goes above the ankle and provides a more precise mold than the slipper sock mold of FIG. 4A.

FIG. 5A depicts the plaster positive foot mold and 5B shows the mold once it has been removed from the negative mold.

FIG. 6 depicts a layer of stockinet prior to being layer over the foot mold to create sufficient space for the individual to slide their foot in and out of the bike shoe.

FIG. 7 depicts the fit of a subject's foot into a bike shoe that was made using 2 ply of stockinet. FIG. 7A is a side view; FIG. 7B is a top view. The fit was too tight to permit easy slide in/slide out movement. This mold was made with the subject wearing Vibram's 5 fingers on the foot.

FIG. 8 depicts the fit of a subject's foot into a bike shoe that was made using 6 ply of stockinet. FIG. 8B is a side view; FIG. 8A is a top view. The fit was just right. This mold was also made with the subject wearing Vibram's 5 fingers.

FIG. 9 depicts the first lamination step in which acrylic resin penetrates and solidifies the composite materials wrapped around the foot mold. FIG. 9A shows one shoe. FIG. 9B shows two shoes from the side.

FIG. 10A depicts a side view and FIG. 10B depicts a top view of a jig that holds the nuts for cleat fixation in a consistent position. FIG. 10C shows how the cleat in one embodiment is secured to the plantar surface of the bike shoe.

FIGS. 11A and 11B depict a bike shoe following the addition of a final layer of fabric and a second lamination with acrylic resin.

FIG. 12 depicts a bike shoe with the final trim line in place. FIG. 12A is a carbon fiber embodiment while FIG. 12B is a composite fiber embodiment.

FIG. 13A depicts a bike shoe with plastic socket edging material secured to the trim line. FIG. 13B depicts an alternative embodiment.

FIG. 14 depicts a bike shoe with plastic socket edging material secured to the trim line as well as a ratchet and buckle to secure the riders foot within the shoe. FIG. 14A is a top view; FIG. 14B is a side view.

FIG. 15 depicts a bike shoe with a heal pad for increased comfort and fit of the bike shoe.

FIG. 16 depicts a standard cleat. The plate (A) is secured to the bike shoe and the cleat (B) is secured to the plate for assembly (C).

FIGS. 17A-C depict a variety of clipless pedals. The cleat attached to the bike shoe locks into a receptacle on the clipless pedal. Clipless pedals may have recessed (E) or non-recessed (D) or receptacles.

FIG. 18 depicts a clip-less pedal on the left (18A) and a pedal engaged in a standard cleat on the right (18B).

FIG. 19A depicts a final shoe with rubberized protective material over the toe box. FIG. 19B shows a reflective decal on the heel.

FIGS. 20A, B, C and D depict the scale used and proper measurements made for proper CFE placement.

FIG. 21 depicts a bike shoe following the addition of a final layer of fabric and a second lamination with acrylic resin.

FIGS. 22 A, B and C shows an alternative jig.

### EXPERIMENTAL

The following examples are provided for illustrative purposes only and are not intended to limit the scope of the invention as defined in the appended claims.

### Example 1

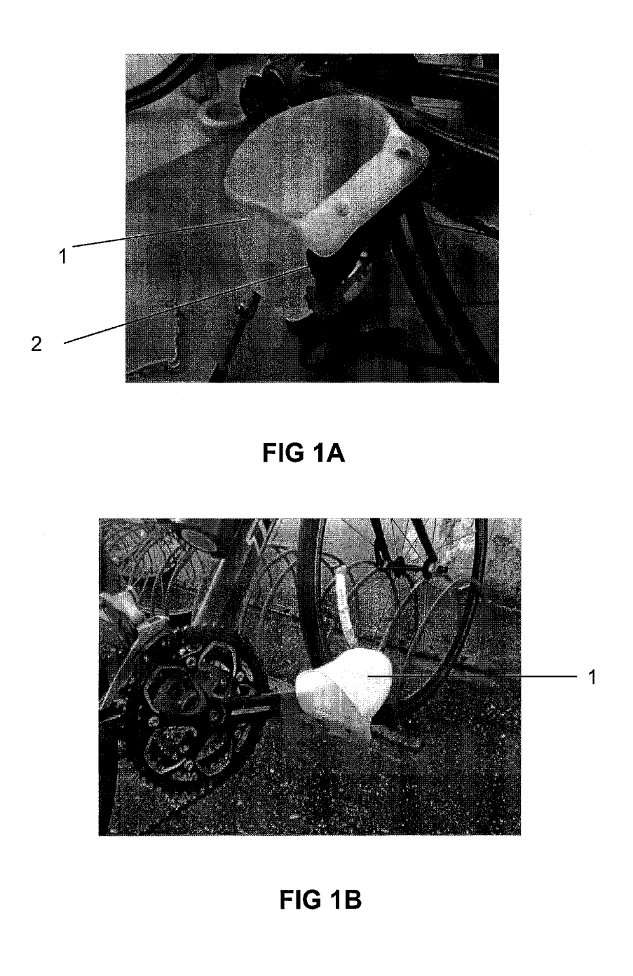

The first prototype (1) was made for a custom fit for the Vibram's running shoe (FIGS. 1A and 1B). The orthotist made a partial plaster mold of the front part of a human subject's foot with the Vibram's running shoes on. From this negative, a positive solid mold was made out of plaster. Materials were vacuumed fitted over this mold and solidified with acrylic resin. This first prototype was made out of polypropyline. It was secured to the cylinder (2) of the pedal. The fit was adequate but there was no support for the hind foot. There was also no ability to have any rotation from the bike shoe to the pedal.

### Example 2

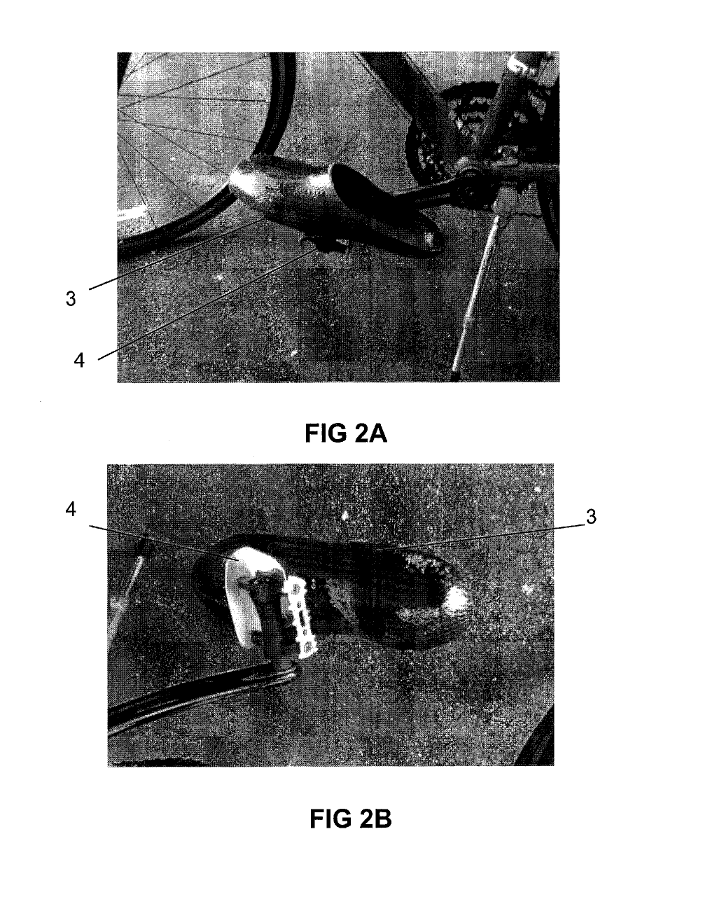

In this example, a full foot mold was utilized with the thought that would be more supportive. The second prototype (3) was made out of carbon fiber material and secured to the pedal (4) in a similar fashion (FIG. 2). This was a much better design and offered more comfort and efficiency with the pedaling motion. With the bike shoe (3) mounted onto the pedal (4), however, there was still no ability to allow for any rotation internally or externally (FIGS. 2A and 2B).

### Example 3

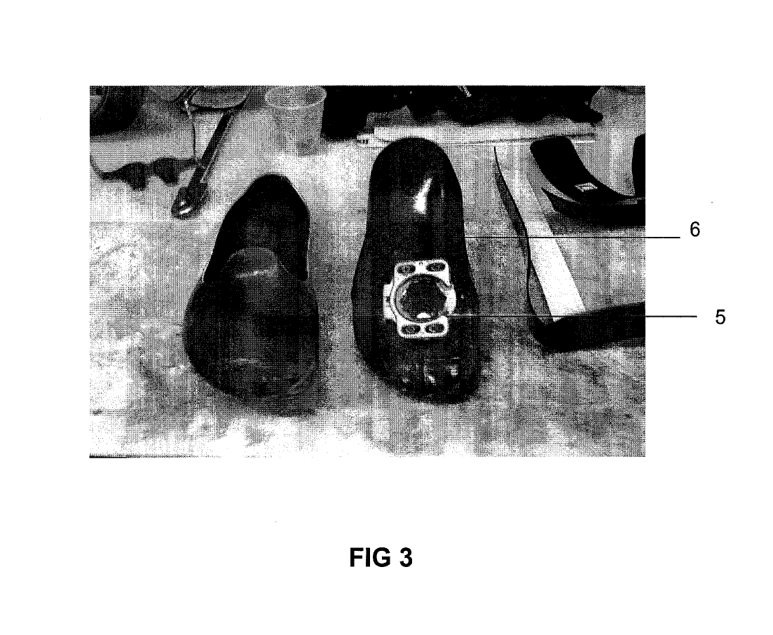

In this example, a construct was made that involved a bike shoe/clip design (FIG. 3). A cleat (5) was incorporated into the undersurface (6) of the custom-made shoe to give excellent durability and support. This concept allows the biker the ability to have some rotational control within the shoe, and the ability to either slide in/slide out the foot from the shoe (i.e. in the case where the shoe remains attached to the bike), or dismount/mount the bike shoe from the pedal (i.e. in which case the shoe is detached and re-attached to the bike).

### Example 4

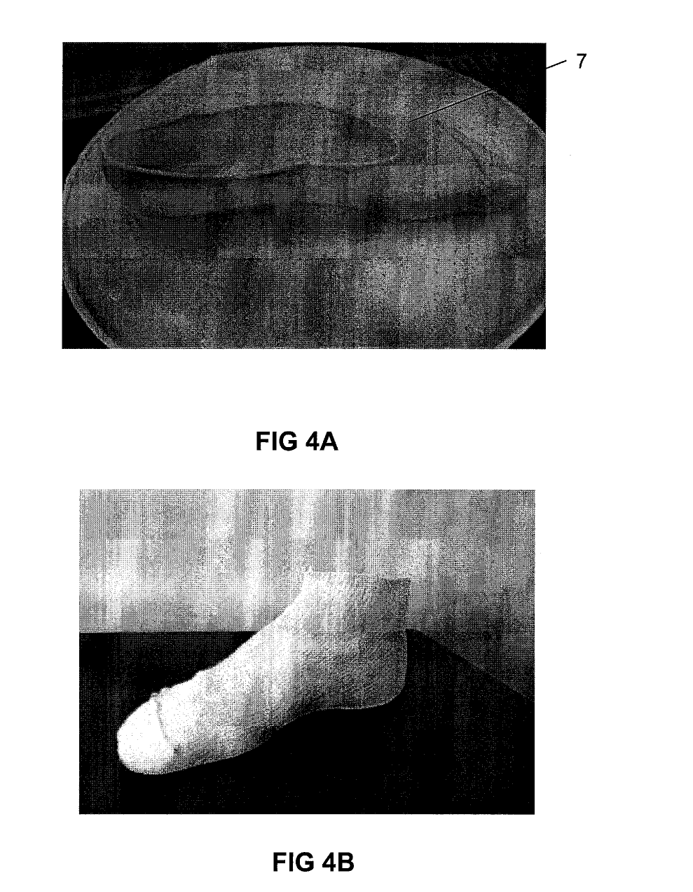

This example describes a better way to create a reproducible, durable, custom mold that is easy for an individual to make on their own. There is a product that exists on the market called STS slipper sock that several orthotists use to create a negative mold (7) that they can then use to manufacture an orthotic form (FIG. 4A). There is also a STS ankle sock (FIG. 4B). This product is very user friendly and gives a much more precise fit than an individual casting of a foot. The steps needed to perform the custom mold can be seen on Youtube.

There are several steps involved in this embodiment for making the custom mold from an individual to create a light weight, durable bike shoe.

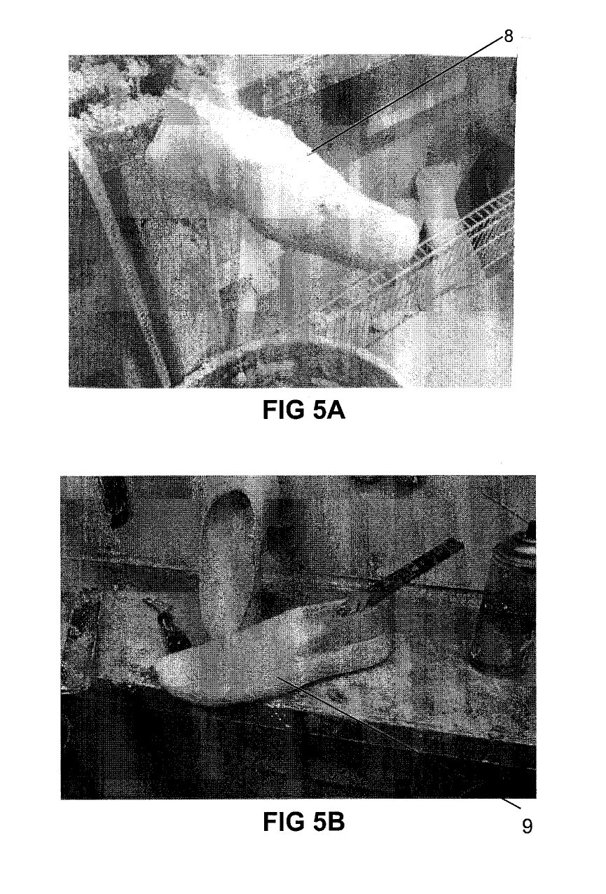

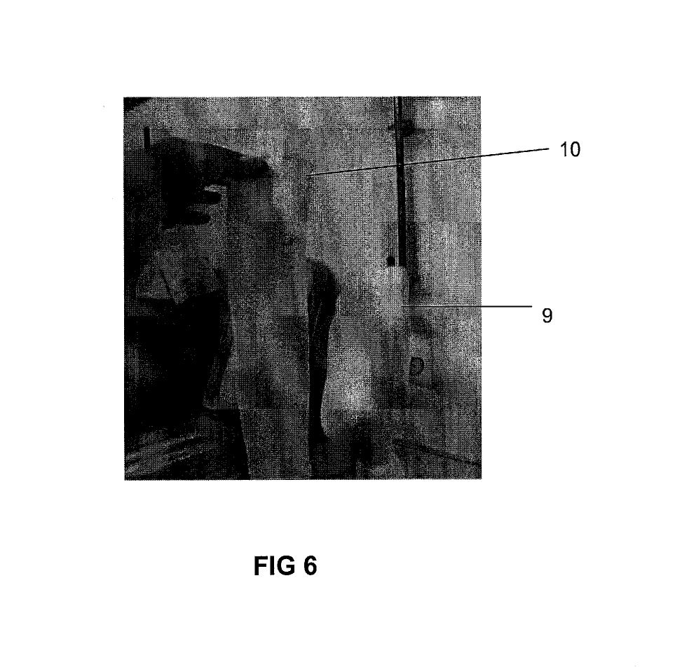

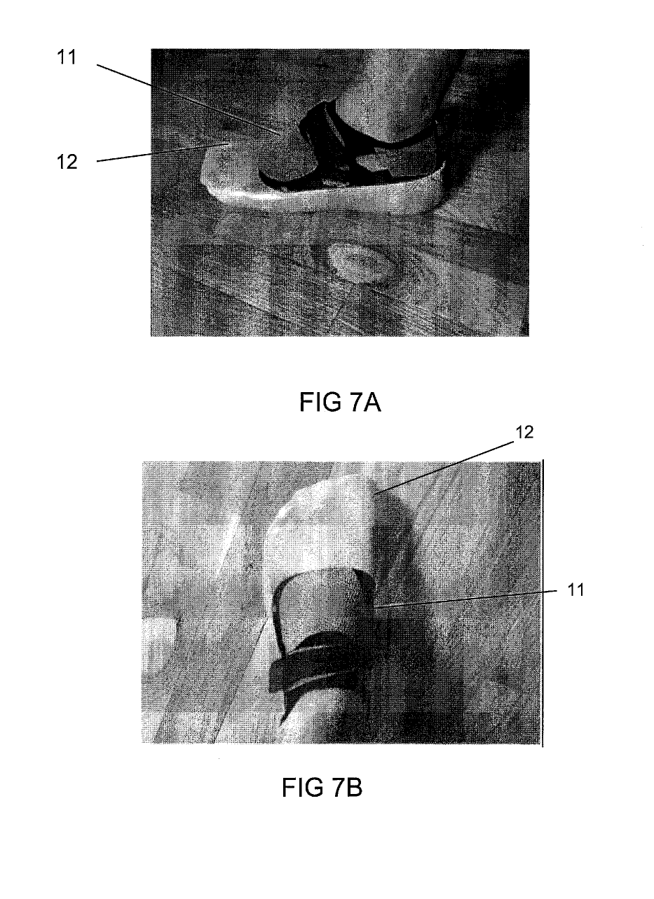

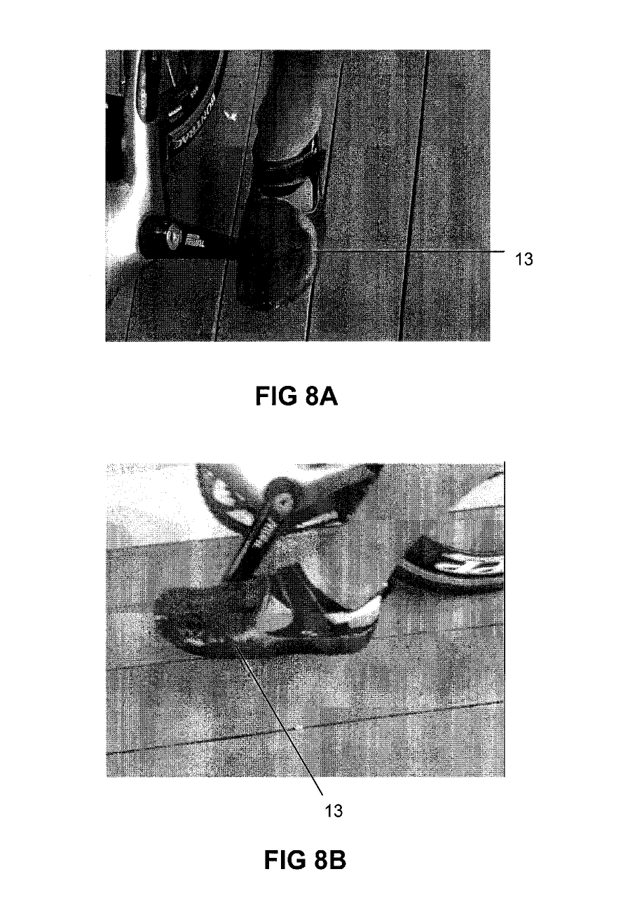

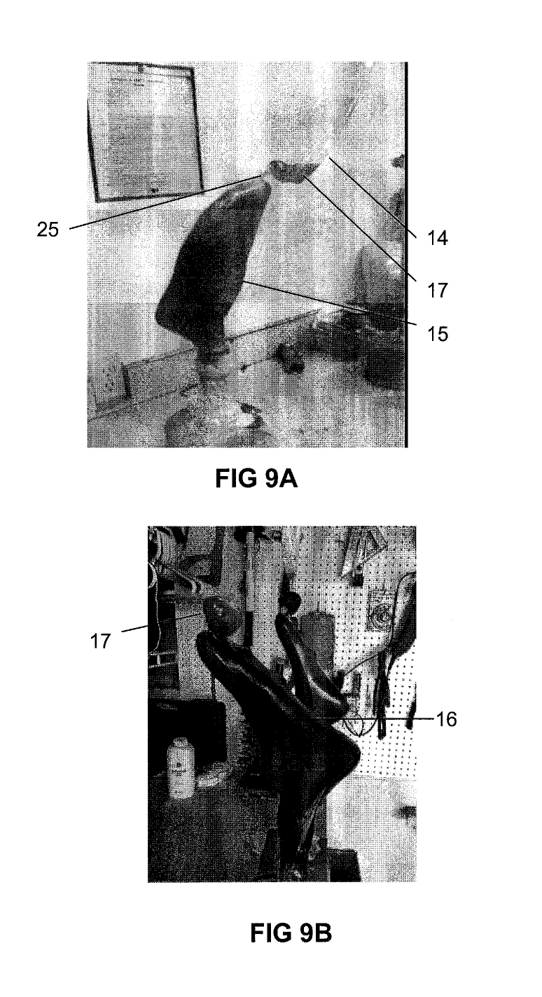

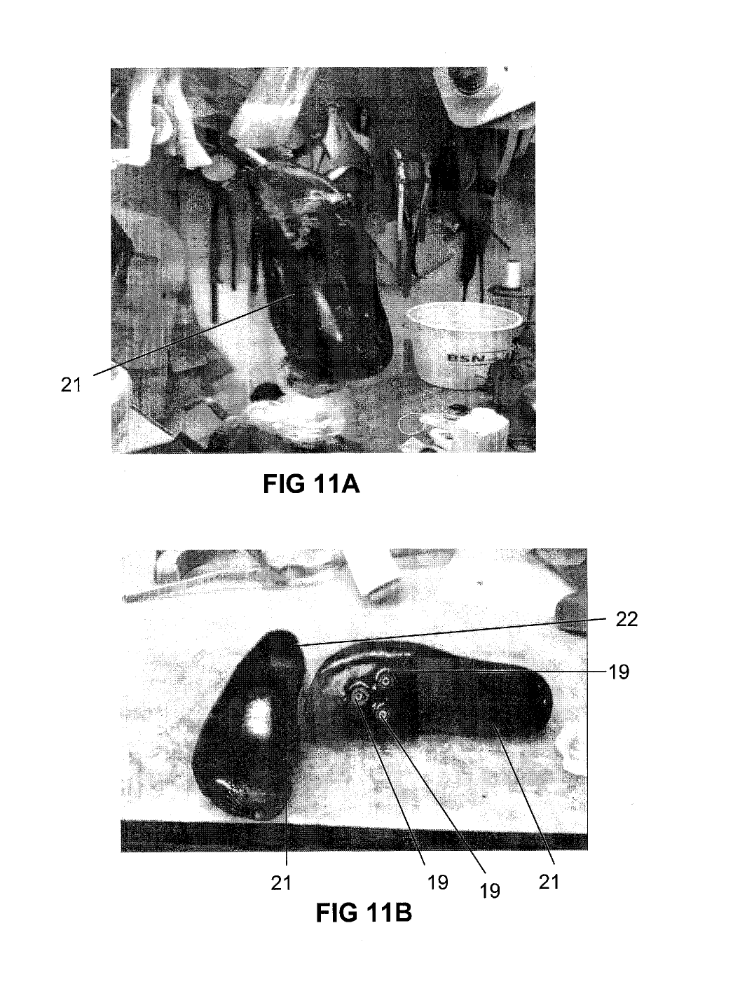

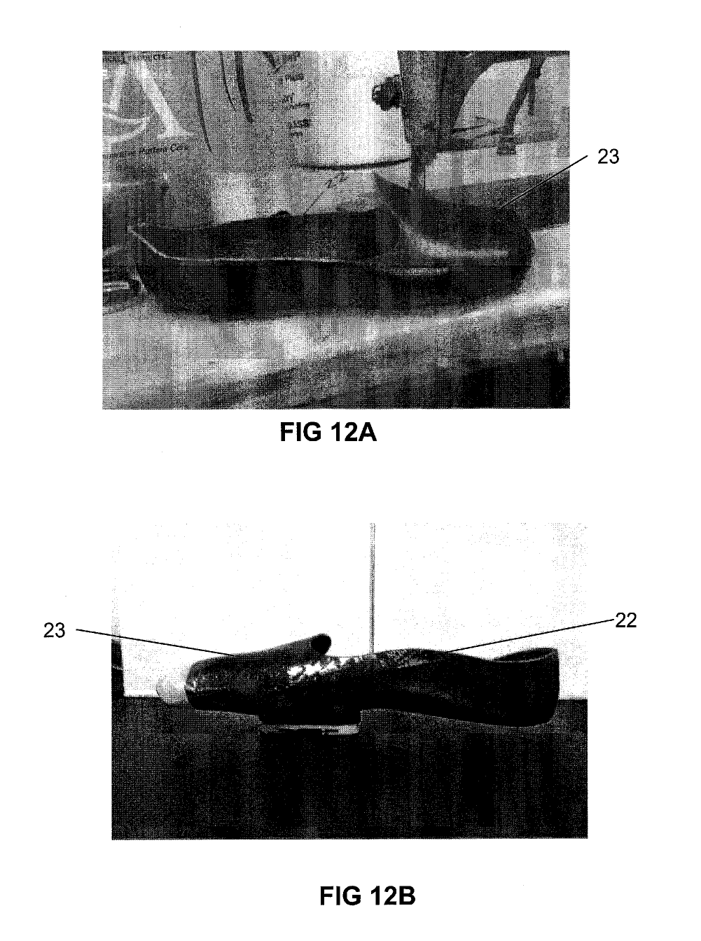

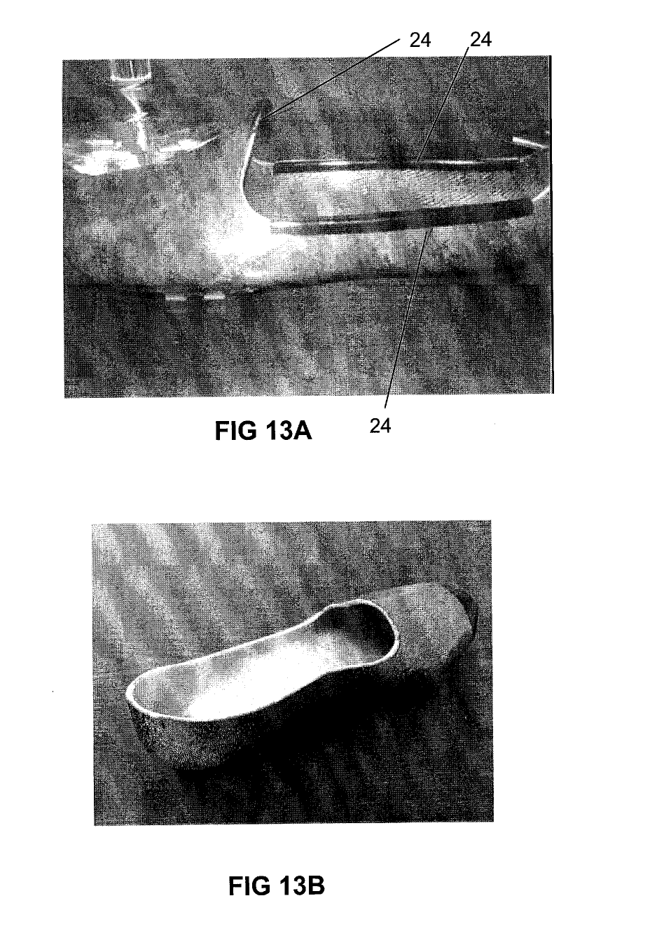

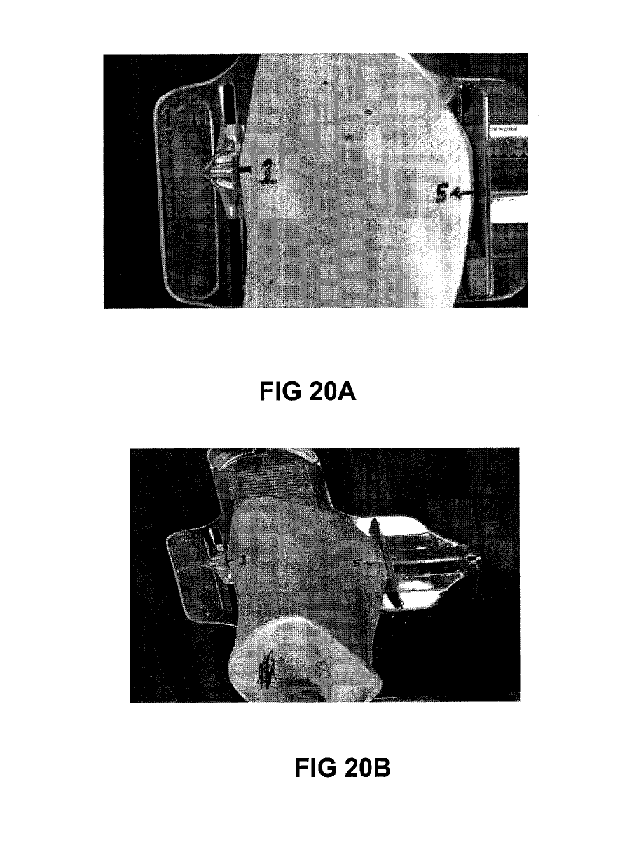

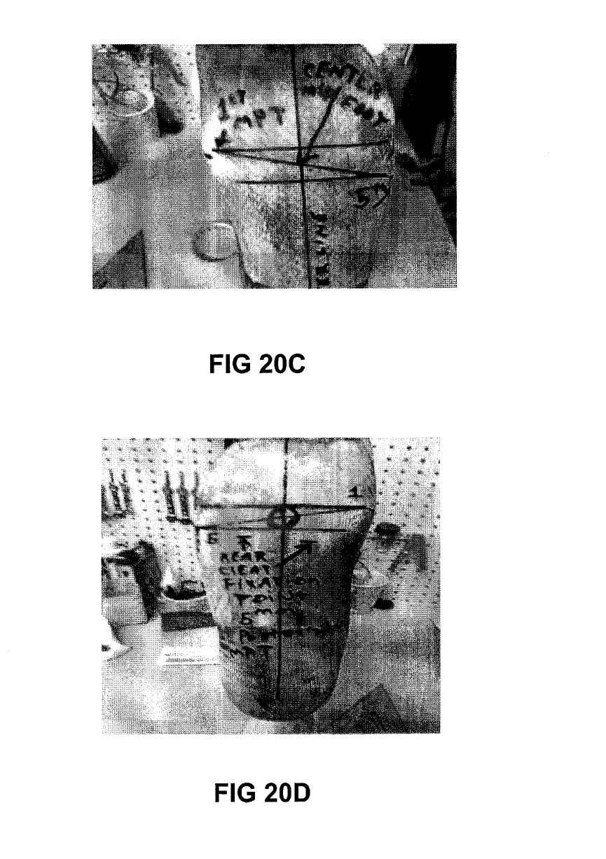

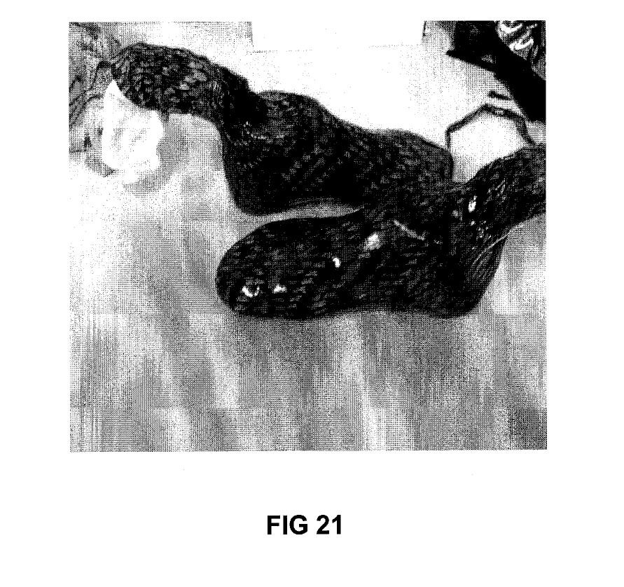

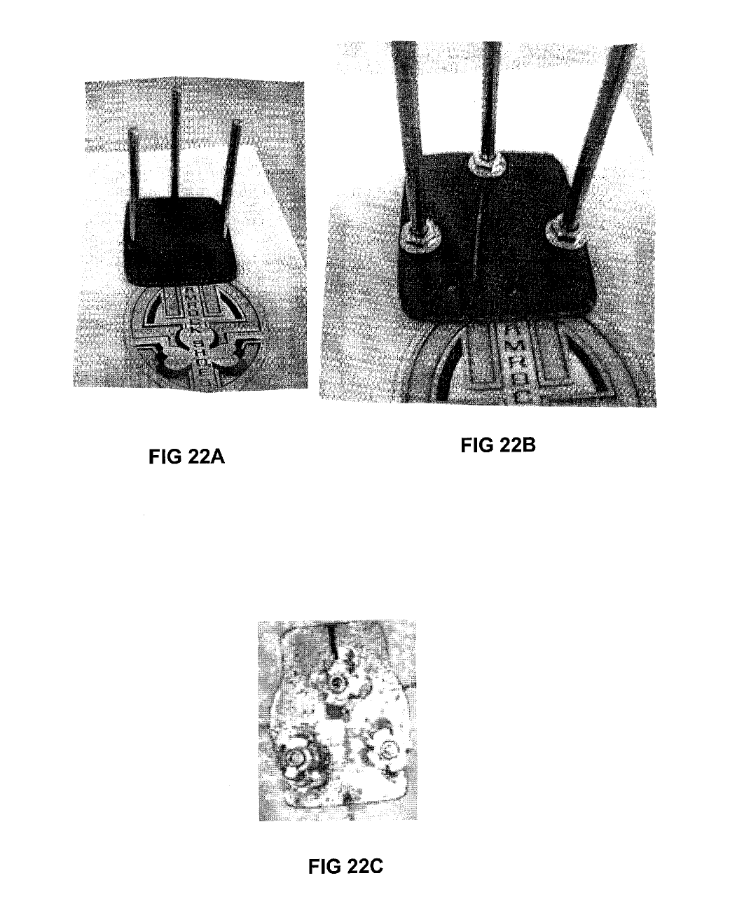

1: Plaster (8) is poured into the negative mold (7) to create a positive foot mold (9) (FIGS. 5A and 5B).
2: Materials are placed over the positive foot mold (9) to create enough space to allow the individual to slide the foot in and out of the shoe (FIG. 6). There was a trial and error process which was necessary to figure out the proper amount of volume expansion. It was decided that 6 layers of stockinet (10) (called 6 ply) is the appropriate thickness to maximize the efficiency and comfort for the individual electing to wear the Vibrams 5 finger shoe (11). Each ply (10) gives ⅛ inch volume expansion. Therefore, 6 ply gives 1.5 inches of global volume expansion. FIGS. 7A and 7B shows a construct with 2 ply that was too snug a fit the shoe (12). FIGS. 8A and 8B show a construct with 6 ply that gave the individual enough space to easily slide the foot in and out of the shoe (13), but it was still snug enough to maximize comfort and efficiency. It was decided that 5 ply for the toebox and 2 ply from the midfoot to the heel was the right size for the barefoot or stocking rider.
3: A first layer of plastic (14) is stretched over the foot mold and hooked up to a suction device to maintain the custom fit (FIG. 9A). Three layers of composite material (15), including nylon and composite fiber (such as Synthex™), are then placed over the foot mold and the undersurface of the metatarsal region (16) for maximum strength for the cleat fixation (FIG. 9B). A second layer of plastic is then stretched over the layers of composite material and hooked to a suction device to maintain the custom fit. The first lamination is performed using acrylic resin (17), which penetrates and solidifies the composite materials between the first and second layers of plastic. In one embodiment, the layers of plastic are plastic bags. In another embodiment, the second layer of plastic (i.e. the second plastic bag) is twisted around itself several times (25) to provide a small aperture through which the acrylic resin (17) is poured.
4: A scale is used to find and mark the 1^{st} and 5^{th} MTP joints (FIGS. 20A and 20B). Measurements are then made to find the center point of cleat fixation and the proper position of the cleat fixation element. (FIGS. 20C and 20D).
5: The final fabric (21) will be the material picked out by the individual for his or her color preference and design. A second acrylic resin (17) lamination is then performed (FIGS. 11A and B).
6: The final trim line (22) of the shoe (23) is performed with the use of the C&C machine. (FIGS. 12A and B).
7: The plaster is then removed from the inner shoe.
8: A plastic socket edging material (24) is secured to the trim line around the shoe (FIG. 13).

### Example 5

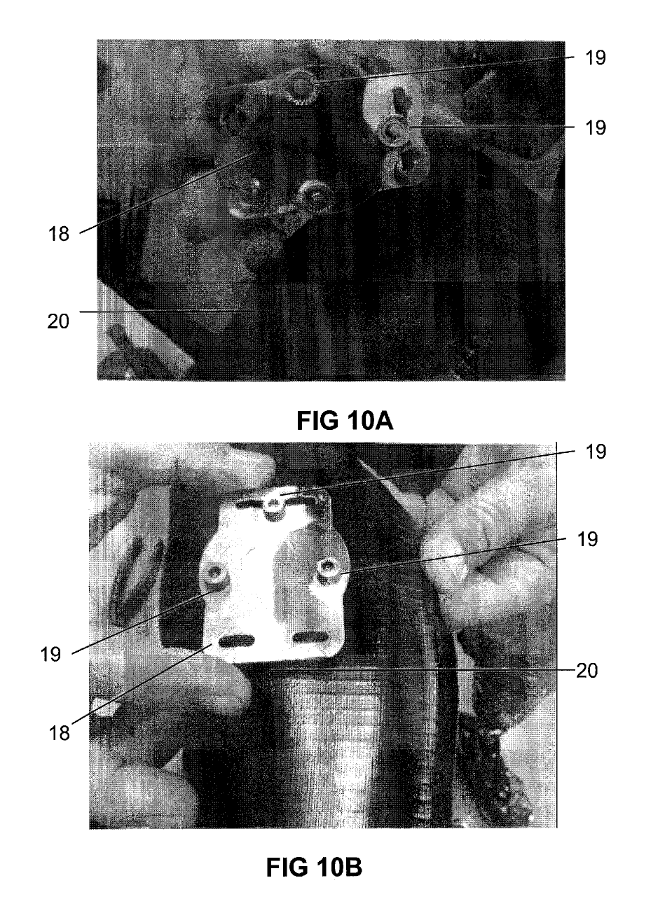

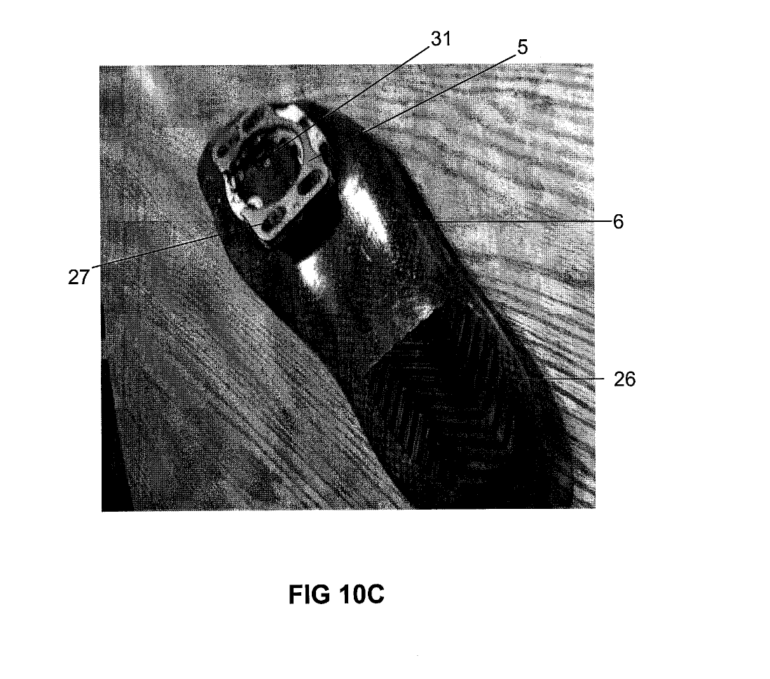

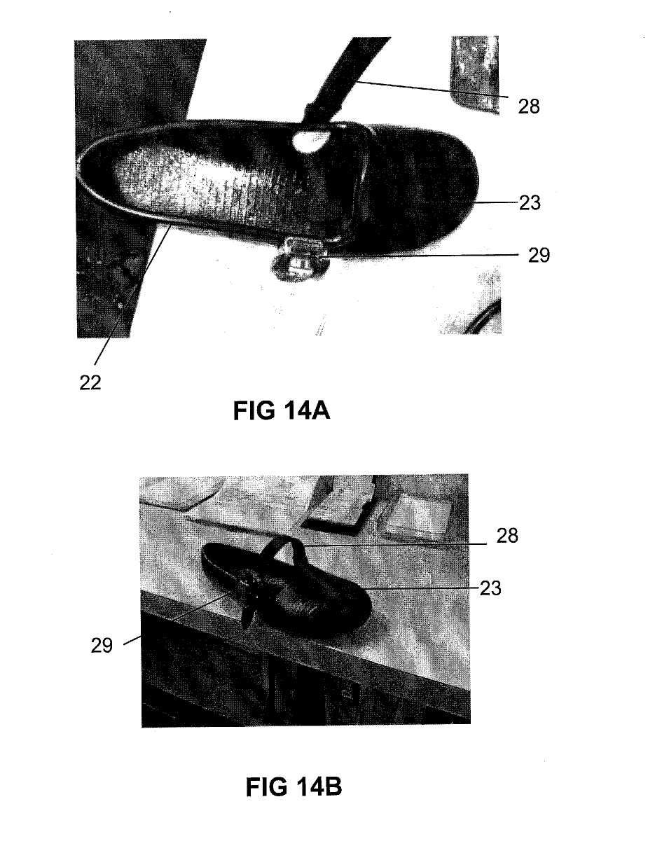

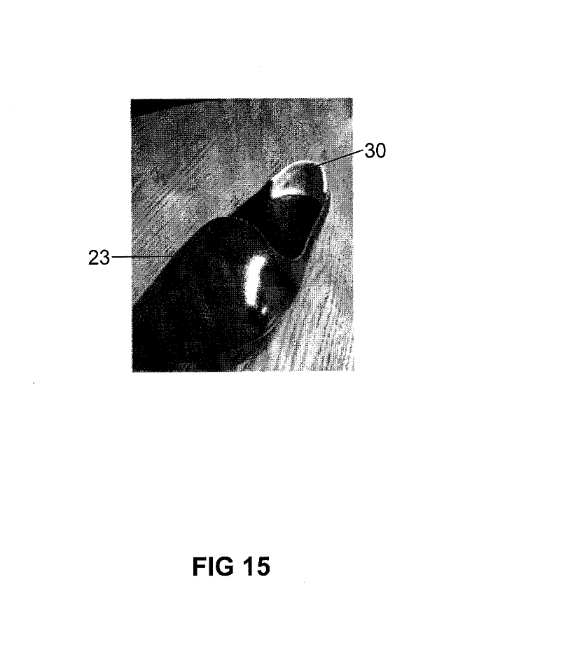

In this example, a construct was made that involved a bike shoe (23) with socket edging material (24) secured around the trim line (22) along with a ratchet (28) and buckle (29) to secure the riders foot within the shoe (FIGS. 14A and B). In one embodiment, the bike shoe optionally incorporates a heel pad (30) to optimize comfort and/or fit for the rider (FIG. 15). In another embodiment, the bike shoe optionally includes rubber padding (26) on the heel of the bike shoe (FIG. 10C).

### Example 6

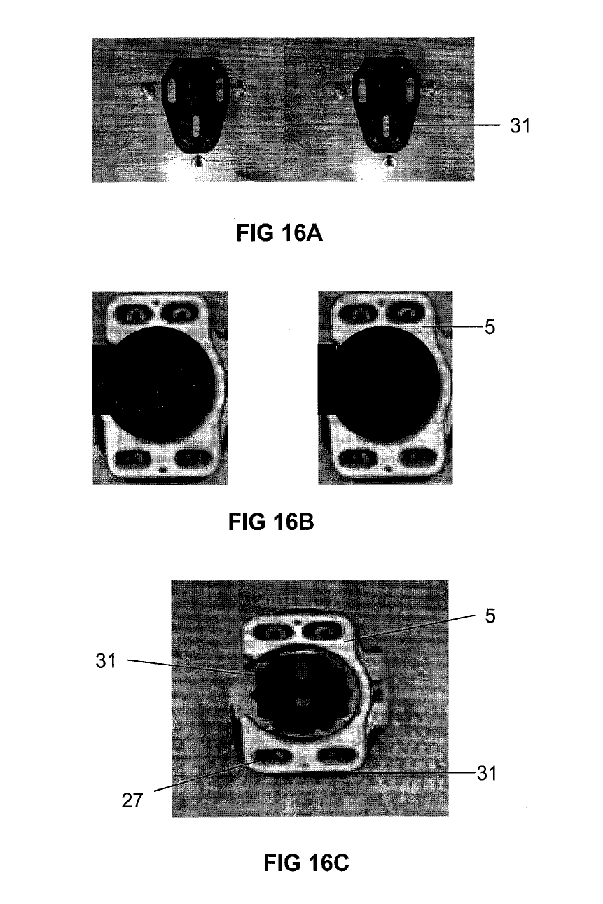

This example depicts a standard cleat. The cleat engaging device comprises a plate (A) that is secured to the bike shoe and the cleat (B) is then secured to the plate (A) (FIG. 16 A-C).

### Example 7

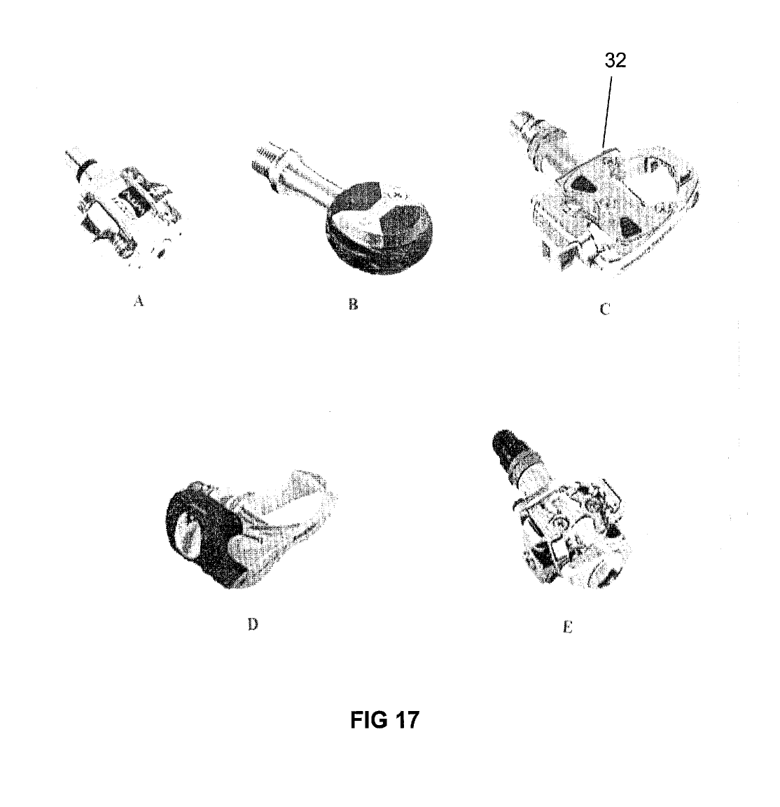

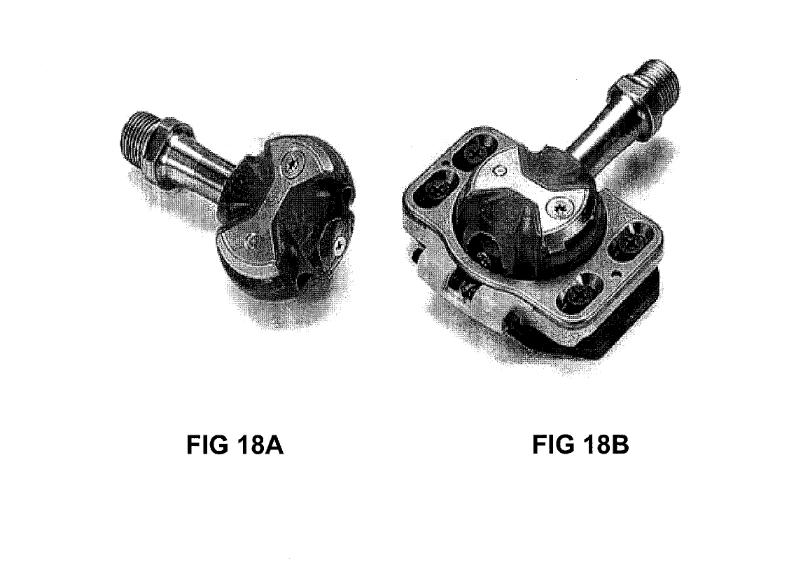

This example depicts a variety of clipless pedals (FIG. 17 A-E). The cleat attached to the bike shoe locks into a receptacle (32) on the clipless pedal. Clipless pedals may have recessed (E) or non-recessed (D) receptacles.

### Example 8

A jig (18) was created to hold the nuts (19) in a consistent position for cleat (5) fixation using screws (27) (FIG. 10A-10C). The nuts (19) are then secured to the plantar surface of the shoe (20) with adhesive, and carbon fiber tape is used in a crisscross pattern to maximize the strength of cleat (5) fixation.

### Example 9

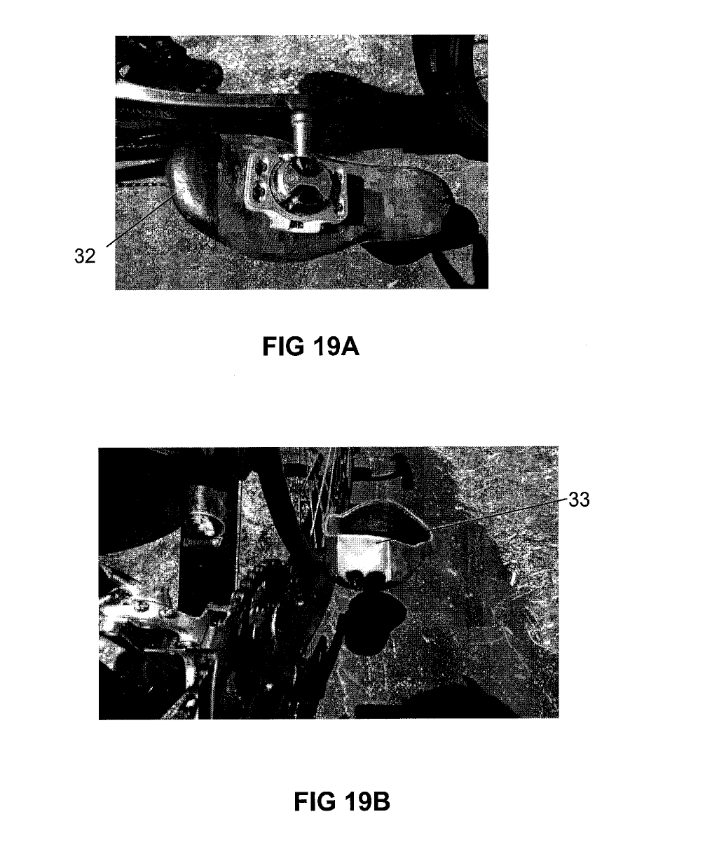

This example describes additional features, including safety features which can be added to the shoe. FIG. 19A depicts a final shoe with rubberized protective material (32) over the toe box. FIG. 19B shows a reflective decal (33) on the heel.

1. A method of making a bicycle shoe, comprising:
a. providing a hardenable, shell-forming fabric and an activating solution;
b. dipping said fabric in said activating solution;
c. applying said fabric to a foot by stretching it over the toes and around the heel of the foot;
d. allowing sufficient time for the fabric to harden and form a shell;
e. removing the hardened shell from the foot;
f. filling the hardened shell with a hardenable solution under conditions such that a hardened mold of the foot is created;
g. covering the foot mold with spacer material to create an expanded foot mold;
h. adding composite materials to the top and bottom of the expanded foot mold to create a precursor shoe;
i. laminating said precursor shoe with a plastic material which penetrates and solidifies the composite materials to form a first laminated shoe;
j. attaching a cleat linking element to the bottom of said first laminated shoe, said cleat linking element configured to engage a cleat, said cleat configured to engage a receptacle on a bicycle pedal;
k. laminating said first laminated shoe to create a twice laminated bicycle shoe;
l. removing the hardened mold thereby freeing the twice laminated bicycle shoe from the mold.

2. The method of claim 1, wherein said plastic material of step (i) is an acrylic resin.

3. The method of claim 1, wherein said compositing materials of step (h) comprise carbon fibers.

4. The method of claim 1, wherein said spacer material comprises a plurality of layers of an elastic knitted fabric.

5. The method of claim 1, wherein said hardenable solution comprises plaster.

6. A bicycle shoe, comprising:
a) top, side, and bottom surfaces comprising composite materials laminated with a plastic material which has penetrated and solidified the composite materials, said surfaces collectively defining the dimensions of an open space inside the shoe;
b) an opening in said top surface of sufficient size to permit a user to insert a foot into the open space inside the shoe in a manner wherein the toes of the foot are completely covered and the heel of the foot engages a side surface; and
c) a cleat linking element positioned on said bottom surface, said cleat linking element configured to engage a cleat, said cleat configured to reversibly engage a receptacle on a bicycle pedal.

7. The shoe of claim 6, wherein said top, side and bottom surfaces are prepared from a mold of the foot of said user.

8. The shoe of claim 6, wherein said opening in said top surface is modified to permit easier insertion and extraction when compared to an unmodified opening.

9. A system comprising a bicycle pedal and bicycle shoe, comprising
a) a receptacle on said bicycle pedal; and
b) a cleat linking element positioned on the bottom of said bicycle shoe engaging a cleat, said cleat configured to reversibly engage said receptacle on said pedal, said shoe comprising
i. top, side, and bottom surfaces comprising composite materials laminated with a plastic material which has penetrated and solidified the composite materials, said surfaces collectively defining the dimensions of an open space inside the shoe; and
ii. an opening in said top surface of sufficient size to permit a user to insert a foot into the open space inside the shoe in a manner wherein the toes of the foot are completely covered and the heel of the foot engages a side surface.

10. The system of claim 9, wherein said top, side and bottom surfaces of the shoe are prepared from a complete mold of the foot of said user.

11. The system of claim 9, wherein said opening in sad top surface is modified to permit easier insertion and extraction when compared to an unmodified opening.
